(19) United States
(12) Patent Application Publication
(10) Pub. No.: US 2003/0189406 A1
(43) Pub. Date: Oct. 9, 2003

(54) Metal halide lamp with ceramic discharge vessel

(75) Inventors: Roland Huttinger, Kaufering (DE); Stefan Juengst, Zorneding (DE); Ruediger Klam, Eichstatt (DE); Dieter Lang, Bruckmuhl (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, Munchen (DE)

(21) Appl. No.: 10/397,356

(22) Filed: Mar. 27, 2003

(30) Foreign Application Priority Data
Apr. 3, 2002 (DE) 102 14 777.9

(51) Int. Cl. H01J 17/04

(52) U.S. Cl. 313/631

(57) ABSTRACT

A metal halide lamp with ceramic discharge vessel (4), the discharge vessel having two ends (6) that are sealed with ceramic stoppers that in each case contain an elongated capillary tube (12), termed stopper capillary below, of inside diameter K, and wherein an electrically conducting lead-through (9, 10), which comprises an inner part (14) and an outer part (13) with reference to the discharge, is guided through this stopper capillary (12) and is sealed outside with glass solder (18), there being fastened on the lead-through an electrode (16) with a stem (15) that projects into the interior of the discharge vessel, the outside diameter S of the inner part being coordinated with the inside diameter K, the inner part (14) being a composite component that comprises a core pin (18) of diameter D onto which there is mounted as a double ply a coil with an effective diameter d of the core wire, the following relationships being fulfilled:

0.8 K≦S≦0.98 K

d≦D

Dₘₐₓ≦0.5 mm

0.16 K≦D≦0.40 K

0.10 K≦d≦0.195 K.

### TECHNICAL FIELD

The invention precedes from a metal halide lamp with ceramic discharge vessel in accordance with the preamble of claim 1. What is involved here, in particular, is lamps with a power of at least 70 W, preferably starting from 100 W up to powers above 1 000 W.

### BACKGROUND ART

EP-A 587 238 discloses a metal halide lamp with ceramic discharge vessel in the case of which a bipartite lead-through is sealed in an elongated stopper capillary by means of glass solder at the end of the stopper remote from the discharge. The outer part of the lead-through consists of permeable material (niobium pin), while the inner part consists of halide-resistance material (for example pin made from tungsten or molybdenum). In accordance with FIG. 8, the inner part has a sheath by virtue of the fact that the pin is wound around with a filament part. The concept presented in this document is, however, suitable only for low powers of up to at most 150 W. The point is that the defective adaptation of the coefficient of thermal expansion frequently leads to cracks in the wall of the ceramic capillary tube in the case of high powers and, consequently, severe alternating thermal loading. These cracks increase with increasing diameter of the molybdenum pin. A similar solution is also disclosed in U.S. Pat. No. 5,751,111.

For higher lamp powers (up to approximately 400 W), a different solution has been applied to date, one which is likewise described in EP-A 587 238, specifically the substitution of the inner Mo pin part by a Cermet part. The coefficient of thermal expansion of the latter can be set as desired between that of other metal parts and that of the ceramic. Disadvantages of the Cermet solutions include not only the high price, but also the defective strength of a welded joint that can be achieved thereby. Moreover, chemical reactions can occur between constitutents of the Cermet and the filling as a result of the high operating temperatures.

There is so far no convincing concept at all for even higher lamp powers.

### DISCLOSURE OF THE INVENTION

It is an object of the present invention to provide a metal halide lamp with ceramic discharge vessel having two ends that are sealed with ceramic stoppers that in each case contain an elongated capillary tube, termed stopper capillary below, of inside diameter K, and wherein an electrically conducting lead-through, which comprises an inner part and an outer part with reference to the discharge, is guided through this stopper capillary and is sealed outside with glass solder such that the outer part of the lead-through is sealed with glass solder over its length located in the stopper capillary, while an area, adjacent thereto, of the inner part of the lead-through is sealed over a small part of the length of from 1 to 2 mm by glass solder, there being fastened on the lead-through an electrode with a stem that projects into the interior of the discharge vessel, the outside diameter S of the inner part being coordinated with the inside diameter K, the implementation of said lamp is designed such that it is suitable not only for small but, in particular, also for larger power levels (typically 150 to 400 W) such that the uniform basic concept is available for the first time.

This object is achieved by means of the following features: the inner part is a composite component that comprises a core pin of diameter D onto which there is mounted as a double ply a coil with an effective diameter d of the coil wire, the following relationships being fulfilled:

0.8 K≦S≦0.98 K

d≦D

Dₘₐₓ≦0.5 mm

0.16 K≦D≦0.40 K

0.10 K≦d≦0.195K.

Particularly advantageous refinements are to be found in the dependent claims.

With the increasing power level, there is usually also an increase in the diameter of the lead-through, and thus necessarily also in the inside diameter of the stopper capillary. A different solution has therefore been developed in order nevertheless reliably to prevent cracks in the sealing area.

What is involved in detail is a metal halide lamp with ceramic discharge vessel, in particular made from aluminum oxide, the discharge vessel having two ends that are sealed by ceramic stoppers (this requiring to be understood as a separate part of a part constructed integrally on the discharge vessel) that contain an elongated capillary tube (called stopper capillary below), and an electrically conducting bipartite lead-through that comprises an inner part and an outer, pin-shaped part with reference to the discharge, being guided in a vacuum-tight fashion through this stopper capillary. The lead-through is sealed outside on the stopper by glass solder. An electrode is fastened inside at the lead-through with its stem and projects into the interior of the discharge vessel.

The inner part of the lead-through comprises a pin made from a halide-resistant metal (preferably molybdenum or tungsten or their alloys) whose diameter is at most 0.5 mm and which is sheathed by a multiply coil, preferably a double ply, of an identical material or one with the same action. It is preferred that the material be molybdenum both for the core pin and for the multiply coil. This has the decisive advantage that the absolute expansions of the individual components (core pin and coil) are below a critical magnitude owing to their low absolute dimensions, such that no cracks occur in the sealing area after the sealing nor during operation of the lamp. Owing to the multiply coil, the electrode system remains flexible so that stresses that occur owing to the expansion during operation or the sealing process can be reduced.

What is decisive is that all these coil geometries come under compressive stress when cooling after the sealing operation because of the different coefficients of expansion of the lead-through, in particular of the coil, and of the surrounding ceramic, that is to say the capillary and the fusible ceramic/glass solder that passes on the pressure thereof. These stresses must be reduced by a single plastic deformation by pressing the coil into the core pin. A bearing surface that is as small as possible is advantageous here.

The particular effect of a coil designed as a double ply or multiply is that the stress-reducing effect can be utilized a second time and very effectively by virtue of the fact that the outer ply is pressed into the inner ply in each case. The point is that a coil can be deformed much more easily than a solid core wire. This mechanism is particularly effective when the outer ply is wound oppositely relatively to the inner ply of the coil, since then crossing points with a high pressure application are formed. A similar statement holds for multiplies.

A similarly effective stress reduction is brought about when a braided core wire is used instead of a plurality of plies. In this case, a particularly high pressure is even produced in the region of the bearing surfaces at the core wire and at the coil inner wire, since the diameter of the braided wire can easily be selected to be smaller than that of the coil inner wire. The diameter w of the braided wire is preferably 30 to 70% of the diameter W of the coil inner wire.

When the lamp is operating, because of the low operating temperatures, the stresses at the sealed point (compared with the sealing temperature) are lower than during the sealing operation. They can therefore be reduced by elastic deformation of the components. Plastic deformation would lead here to premature leakiness.

The outer part of the lead-through is sealed with glass solder over its length located in the stopper capillary. In addition, an area, adjacent thereto, of the inner part of the lead-through is sealed by glass solder over a small part of the length (approximately 1 to 2 mm). It has proved in this case to be important for a long service life that the inner part have an outer dimension that corresponds at least to 0.8 times, and at most to 0.98 times the inside diameter of the capillary.

Further important preconditions are that the maximum diameter of the core pin be less than or equal to 0.5 mm, and that the diameter of the plies of the core wire correspond at most to the diameter of the core pin. However, the diameter of each ply is preferably smaller than that of the core pin. However, the diameter of each ply is preferably smaller than that of the core pin. However, the diameters of the two plies need not be the same.

The power of the lamp is preferably between 100 and 1000 W, but higher powers (2000 W and more) and lower powers (for example 70 W) are also possible.

If D is used to denote the diameter of the core pin, and d that of the filament wire, while K denotes the inside diameter of the capillary, it holds firstly that:

0.8 K≦S≦0.98 K.

Here, S is the entire diameter of the inner part of the lead-through, that is to say in general S=D+nd, n being the number of the formal plies. In the case of a double ply, it follows that S=D+4d. It has emerged according to the invention that a reliable seal is achieved when it holds for the diameter D of the core pin that:

0.16 K≦D≦0.40 K.

Moreover, it is also to hold for the diameter d of the core wire that:

0.10 K≦d≦0.195 K.

In the case of a different diameter for the two coil plies (d₁and d₂), it is to hold for the formulas that: d₁ +d₂=2 d. In other words, an effective mean diameter d is then to be counted on. In general, it can be expressed in the case of a plurality of plies by d₁+ . . . +dₙ=n d such that d=(d₁+ . . . +dₙ)/n holds.

In a further alternative embodiment, which can be used starting from 150 W, the core wire is spun around with a braided filament wire. If D is the core wire diameter, W the filament wire diameter and w the braided wire diameter, it holds here in principle that

S=D+2(W+2 w),

with the boundary condition that

D>(W+2w).

This boundary condition results from reasons of winding technology, since the core wire must be thicker than the braided filament wire.

The ranges specified above for D and d are also valid here.

It preferably holds for w that

0.04 K≦w≦0.1 K.

In the case of high wattages from 600 W (particularly around 1000 W and more), it can happen that the maximum diameter in accordance with the original formula mentioned above could be more than 0.5 mm, but this should be avoided for the purpose of a durable seal. It is advantageous in such cases to use a modified coil, either by using a third ply over the double ply, or by having at least one ply comprising not a single coil (sc), but a double coil (coiled coil, sc, or braided wire), in a similar fashion as already described above as an alternative for lower wattages.

It holds with particular preference for wattages from 100 to 1 000 W, particularly in the case of double plies, that:

0.25 K≦D≦0.30 K.

It is to hold for the diameter d of the coiled wire that:

0.12 K≦d≦0.15 K.

The diameter of the core pin is preferably to be at most 0.35 mm.

A relationship between filament wire and core pin in which they are well coordinated with one another is in the range of

(0.90 K−D)/4≦d≦(0.96 K−D)/4.

The present invention uses a bipartite lead-through comprising an outer part whose thermal expansion is adapted to the (aluminum oxide) ceramic, which is permeable to H₂ and O₂ (being, in particular, a pin or tube made from niobium, although the use of tantalum is also possible) and which is covered and sealed with glass solder, and an inner part that is halide-resistant and is covered only partially with glass solder at its outer end and sealed. The inner part is a very thin wire made from molybdenum or from the higher-melting tungsten. The tungsten can have an addition of rhenium, either as an alloy or as a surface plating. The rhenium increases the high-temperature stability and corrosion resistance of the tungsten. While molybdenum is particularly well suited for fillings containing mercury, W is used advantageously for fillings free from mercury. In particular, W is also suitable for relatively low powered lamps from 70 W.

At one end, the inner part is connected to the outer part (niobium pin or niobium tube), and at the other end it is connected to the electrode.

The stopper can be of unipartite, or else of multipartite design. For example, a stopper capillary can be surrounded in a known way by an annular stopper part.

Finally, by contrast with the prior art no role is played by how deep the outer part is inserted into the stopper capillary. All that a reliable sealing requires is a minimum depth of 2 mm. For thermal reasons, the maximum depth of insertion should preferably not exceed 50% of the length of the stopper capillary.

The outer part is sealed completely into the glass solder over its length located in the stopper capillary, while the inner part is sealed over a length of approximately 1 to 2 mm at its outer end. It is important that the niobium pin be completely covered by glass solder because of the corrosive effect of the filling on niobium.

### BRIEF DESCRIPTION OF THE DRAWINGS

The invention is to be explained below in more detail with the aid of a plurality of exemplary embodiments. In the drawing:

FIG. 1 shows a schematic of a metal halide lamp with ceramic discharge vessel,

FIG. 2 shows a schematic of the end region of the lamp of FIG. 1, in detail,

FIG. 3 shows a schematic of a further exemplary embodiment of an end region, and

FIGS. 4 and 5 each show a schematic of a further exemplary embodiment of an end region.

### BEST MODE FOR CARRYING OUT THE INVENTION

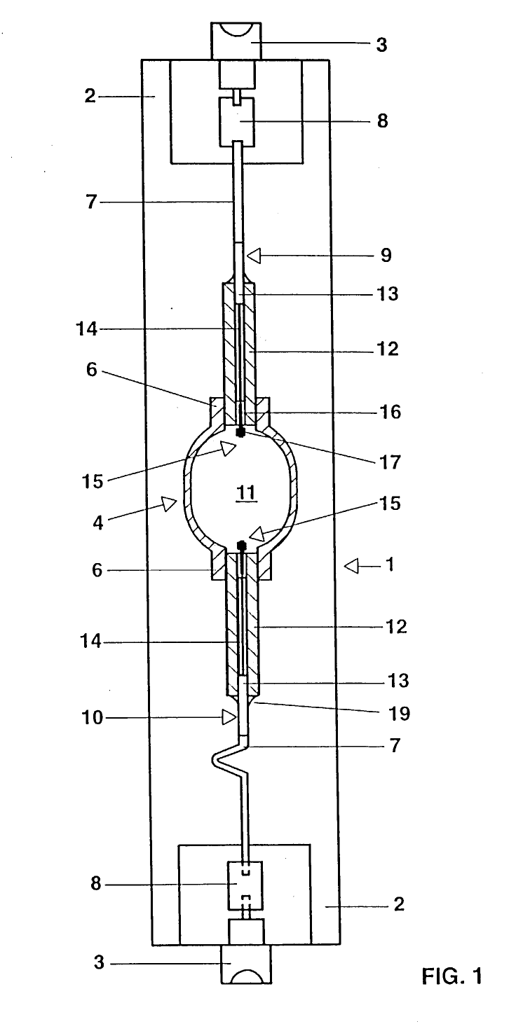

A metal halide lamp with a power of 150 W is illustrated schematically in FIG. 1. It comprises a cylindrical outer bulb 1, which is made from quartz glass, defines a lamp axis and is pinched (2) and provided with a base (3) at both ends. The axially arranged discharge vessel 4 made from Al₂O₃ ceramic is of cylindrical or convex shape and has two ends 6. It is held in the outer bulb 1 by means of two supply leads 7 that are connected to the base parts 3 via foils 8. The supply leads 7 are welded to lead-throughs 9, 10 which are fitted in each case in an end stopper 12 at the end 6 of the discharge vessel. The stopper part is designed as an elongated capillary tube 12 (stopper capillary). The end 6 of the discharge vessel and the stopper capillary 12 are directly sintered to one another, for example.

The lead-throughs 9, 10 each comprise two parts. The outer part 13 is designed in each case as a niobium pin and projects into the capillary tube 12 up to approximately one quarter of the length thereof. The inner part 14 extends within the capillary tube 12 as far as the discharge volume. It holds, at the discharge-side end, electrodes 15 comprising an electrode stem 16 made from tungsten, and a filament 17 pushed on at the discharge-side end of the stem. The inner part 14 of the lead-through, specifically the core pin, is welded in each case to the electrode stem 15 and to the outer part 13 of the lead-through.

In addition to an inert ignition gas, for example argon, the filling of the discharge vessel consists of mercury and additions of metal halides. Also possible, for example, is the use of a metal halide filling without mercury, it being preferred to select xenon as ignition gas and, in particular, a higher pressure, substantially above 1.3 bars.

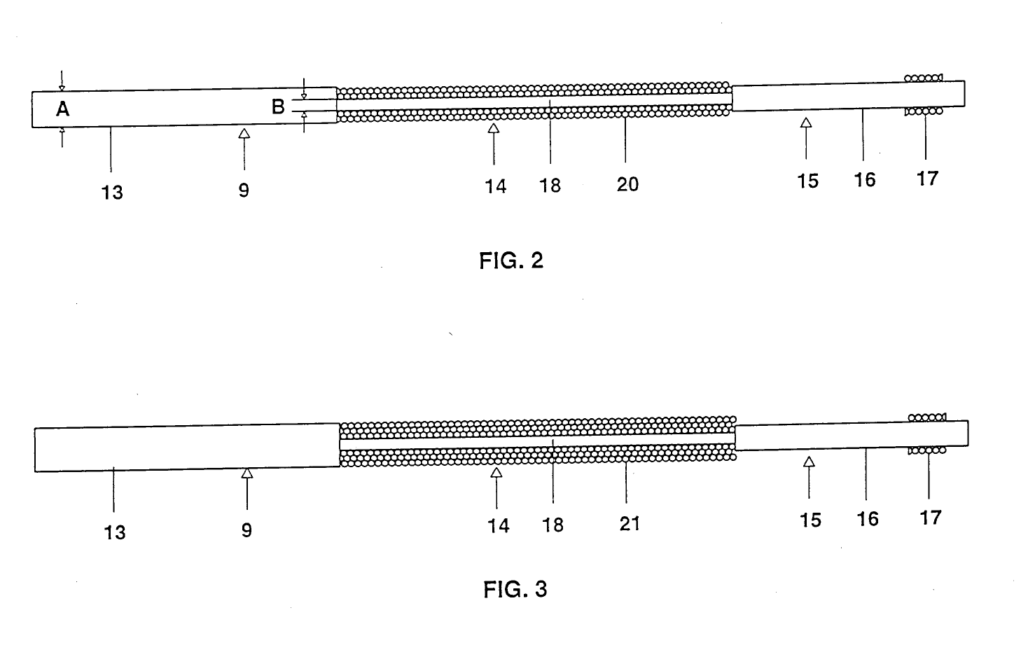

An end region of the discharge vessel is shown in detail in FIG. 2. Serving as lead-through 9, 10 is a system comprising a niobium pin (or else tube) as outer part 13, with a diameter A and a thin molybdenum pin 18 (diameter B, see table 1 below respectively for this) as constituent of the inner part 14, over which two plies of a molybdenum coil 20 with a wire diameter C in each case are pushed. The total length of the capillary tube 12 is approximately 17 mm, that of the niobium pin 13 is D, and that of the inner part 14 is E, in conjunction with an inside diameter of F for the stopper capillary.

The niobium pin 13 is butt welded at the discharge end to the core pin 18 made from molybdenum. The core pin 18 is welded onto the electrode stem 16 in the same way at the discharge end.

The niobium pin 13 is inserted into the stopper capillary 12 to a depth of approximately 3 mm and sealed by means of glass solder 19. It is important in this case that the glass solder completely covers this niobium pin and also that the start of the inner part (1 to 2 mm) is still covered by the glass solder.

TABLE 1

| Power | Feature | 150 W | 250 W | 400 W |
|---|---|---|---|---|
| Diameter | A | 0.88 | 1.00 | 1.30 |
| Nb pin (mm) | | | | |
| Diameter | B | 0.25 | 0.30 | 0.30 |
| Mo core pin (mm) | | | | |
| Diameter | C | 0.15 | 0.18 | 0.25 |
| Mo filament (mm) | | | | |
| Length of Nb pin | D | 8 | 10 | 12 |
| (mm) | | | | |
| Length of inner | E | 10 | 13 | 17 |
| part (mm) | | | | |
| Min. inside | F | 0.90 | 1.05 | 1.35 |
| diameter of | | | | |
| capillary tube (mm) | | | | |

Dimensions of the enclosed table 1 are used in the case of an exemplary embodiment of a 150 W lamp in accordance with FIG. 2. The preferred dimensions are also specified for wattages of 250 W and 400 W in the same way.

Table 2 shows for various rating classes the typical inside diameters of the capillary tube as well as the minimum and maximum permissible diameters of the core pin 18 (D) and the core 20 (d). The same diameter of the two plies is assumed here in each case, something which is frequently the simplest and the best solution. However, the diameters of the two plies can be different, in particular the diameter of the outer ply can be selected to be substantially smaller (30% and more) than that of the inner ply.

TABLE 2

| | Typical | | | | |
|---|---|---|---|---|---|
| | capillary | | | | |
| Rating | inside | | | | |
| class | diameter | D-min. | D-max. | d-min. | d-max. |
| [W] | [mm] | [mm] | [mm] | [mm] | [mm] |
| 70 | 0.80 | 0.128 | 0.32 | 0.116 | 0.164 |
| 100 | 0.85 | 0.136 | 0.34 | 0.123 | 0.174 |
| 150 | 0.95 | 0.152 | 0.38 | 0.138 | 0.195 |
| 200 | 1 | 0.16 | 0.4 | 0.145 | 0.205 |
| 250 | 1.1 | 0.176 | 0.44 | 0.159 | 0.226 |
| 300 | 1.2 | 0.192 | 0.48 | 0.174 | 0.246 |
| 350 | 1.3 | 0.208 | 0.5 | 0.193 | 0.267 |
| 400 | 1.4 | 0.224 | 0.5 | 0.218 | 0.287 |
| 600 | 1.5 | 0.24 | 0.5 | 0.242 | 0.308 |
| 1000 | 2.2 | 0.352 | 0.5 | 0.414 | 0.451 |
| 2000 | 3.1 | *) | *) | *) | *) |

*) Not possible to fulfill conditions for 2-ply coil; therefore use 3-ply coil or alternative design

TABLE 3

| | Typical | | | | |
|---|---|---|---|---|---|
| | capillary | D- | D- | d- | d- |
| Rating | inside | preferred | Preferred | preferred | preferred |
| class | diameter | min. | max. | min. | max. |
| [W] | [mm] | [mm] | [mm] | [mm] | [mm] |
| 70 | 0.80 | 0.16 | 0.24 | 0.12 | 0.156 |
| 100 | 0.85 | 0.17 | 0.255 | 0.128 | 0.166 |
| 150 | 0.95 | 0.19 | 0.285 | 0.143 | 0.185 |
| 200 | 1 | 0.2 | 0.3 | 0.15 | 0.195 |
| 250 | 1.1 | 0.22 | 0.33 | 0.165 | 0.214 |
| 300 | 1.2 | 0.24 | 0.35 | 0.183 | 0.234 |
| 350 | 1.3 | 0.26 | 0.35 | 0.205 | 0.253 |
| 400 | 1.4 | 0.28 | 0.35 | 0.228 | 0.273 |
| 600 | 1.5 | 0.3 | 0.35 | 0.25 | 0.292 |
| 1000 | 2.2 | *) | *) | *) | *) |
| 2000 | 3.1 | *) | *) | *) | *) |

*) Not possible to fulfill conditions for 2-ply coil; therefore use 3-ply coil or alternative design

TABLE 4

| | Typical | | |
|---|---|---|---|
| | capillary | | |
| Rating | inside | D | d |
| class | diameter | optimized | optimized |
| [W] | [mm] | [mm] | [mm] |
| 70 | 0.80 | 0.20 | 0.14 |
| 100 | 0.85 | 0.212 | 0.149 |
| 150 | 0.95 | 0.237 | 0.166 |
| 200 | 1 | 0.25 | 0.175 |
| 250 | 1.1 | 0.275 | 0.192 |
| 300 | 1.2 | 0.295 | 0.211 |
| 350 | 1.3 | 0.305 | 0.232 |
| 400 | 1.4 | 0.315 | 0.254 |
| 600 | 1.5 | 0.325 | 0.275 |
| 1000 | 2.2 | *) | *) |
| 2000 | 3.1 | *) | *) |

*) No optimum solution in the case of a double-ply coil

Also specified in table 3 for different power levels is a preferred range for the values discussed in table 2. Finally, an optimum value for D and d is respectively specified for concrete wattages in table 4.

It is no longer possible in part directly to satisfy the prescribed condition given high-power rating classes, and in these cases alternative techniques can also be used.

The simplest alternative is to use a further ply of the coil 21, as illustrated in FIG. 3. In this design of a threefold coil 21 for 1 000 W lamp, the core wire has a diameter of 0.35 mm, and the coil wire has a diameter of 0.29 mm.

Further examples of this technique are shown in table 5, the rating class, the inside diameter of the capillary tube and the diameters of the core pin and of the coil wire being specified. Of course, the diameter of individual plies can also differ here.

TABLE 5
Examples of three-ply coils

| | Typical | | |
|---|---|---|---|
| | capillary | | |
| Rating | inside | | |
| class | diameter | D | d |
| [W] | [mm] | [mm] | [mm] |
| 600 | 1.5 | 0.3 | 0.19 |
| 1000 | 2.2 | 0.35 | 0.29 |
| 2000 | 3.1 | 0.45 | 0.42 |

Finally, a similar effect can also be achieved by making use not of a multiply coil but of a doubly coiled coil (cc) with a single or double ply. The single ply of a doubly coiled coil corresponds in this case approximately to a threefold ply of a single coil. In this case, the core wire of the coil, which functions formally as middle ply, usually has a larger diameter than the wire braided thereon, which forms the innermost and outermost ply.

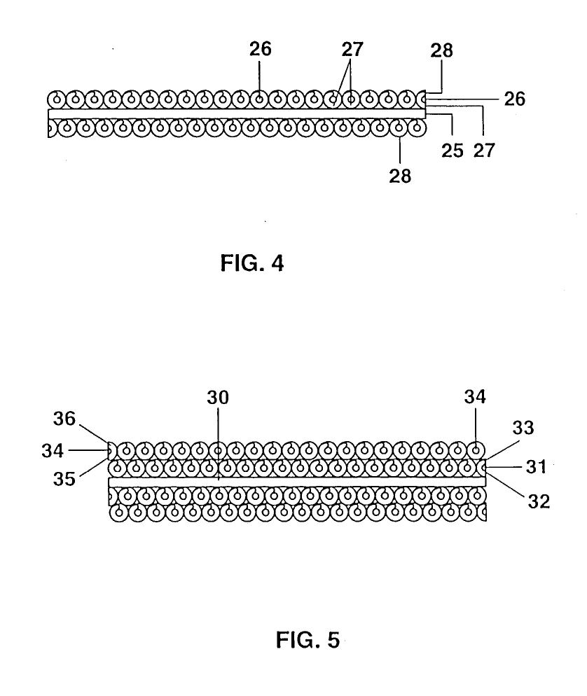

The principle is illustrated in FIG. 4. The core wire 25 made from molybdenum has a diameter of 0.35 mm for a 1000 W lamp. The cc coil (one ply) applied thereto has an inner pin 26 (core wire of the coil) with a diameter of 0.35 mm (formally middle ply) and the wire, braided thereon, with a diameter of 0.25 mm which thus forms the inner and outer plies 27 and 28 in formal terms. A plurality of examples are specified in table 6 for such high-power lamps.

TABLE 6
Examples of simple cc coils:

| | Typical | | | |
|---|---|---|---|---|
| | capillary | | | |
| Rating | inside | | | |
| class | diameter | D | W | w |
| [W] | [mm] | [mm] | [mm] | [mm] |
| 600 | 1.5 | 0.3 | 0.2 | 0.18 |
| 1000 | 2.2 | 0.35 | 0.32 | 0.27 |
| 2000 | 3.1 | 0.45 | 0.43 | 0.41 |

D = inner core wires: W = core wire coil; w = filament wire

The double ply of a doubly-coiled coil corresponds approximately to a formal sixfold ply of a single coil. The diameter of the plies differs here in each case.

In accordance with FIG. 5, a double ply of a cc filament is applied to the core wire 30, each ply being a coiled-coil (cc) with a core wire. The dimensions of the two plies can differ. The first ply has a first core wire 31 (thus forming the second ply in formal terms), about which a filament is wound, which therefore forms the first and third plies 32 and 33 in formal terms. In the same way, the second ply has a second core pin 34 (fifth ply in formal terms) about which a filament is wound that therefore forms the fourth and sixth plies 35, 36 in formal terms.

The dimensioning of the core pin and of the coiled-coil are specified in table 7 for various wattages. The coiled coil is used for both plies.

TABLE 7
Examples for two plies of a coiled-coil;

| | Typical | | | |
|---|---|---|---|---|
| | capillary | | | |
| Rating | inside | | | |
| class | diameter | D | W | w |
| [W] | [mm] | [mm] | [mm] | [mm] |
| 600 | 1.5 | 0.2 | 0.15 | 0.08 |
| 1000 | 2.2 | 0.25 | 0.2 | 0.13 |
| 2000 | 3.1 | 0.28 | 0.28 | 0.19 |

D = inner core wire; W = core wire coil; w = filament wire

The dimensioning of the core pin and of the braiding coil (one ply of a coiled-coil) are specified in table 8 for 150-400 W. In these exemplary embodiments, said braiding coil lies in only one ply on the core pin. A concrete example is a 150 W lamp with a lead-through that has an Mo part in the case of which the core wire has a diameter of 0.3 mm, while the coil wire has an inner filament wire of diameter 0.13 mm that is braided with a thin wire of diameter 0.07 mm. The result in formal terms is a three-ply coil with as many crossing points as desired. The advantage of this embodiment is, in particular, that the core wire also has only contact points with the coil, while, in sc versions, the innermost ply has a continuous bearing surface at the core wire. This example corresponds to the illustration of FIG. 4.

TABLE 8
Examples for one ply of a coiled-coil;

| | Typical | | | |
|---|---|---|---|---|
| | capillary | | | |
| Rating | inside | | | |
| class | diameter | D | W | w |
| [W] | [mm] | [mm] | [mm] | [mm] |
| 150 | 0.95 | 0.3 | 0.13 | 0.07 |
| 250 | 1.0 | 0.4 | 0.16 | 0.07 |
| 400 | 1.3 | 0.5 | 0.2 | 0.1 |

D = inner core wire; W = core wire coil; w = filament wire

All the plies are tightly wound. However, it is not excluded to observe a smaller spacing (up to 20% of the wire diameter) of the individual turns. An excessively high pitch factor has the disadvantage that the interspaces act as additional undesired dead volume for the filling.

What is claimed is:

1. A metal halide lamp with ceramic discharge vessel, the discharge vessel having two ends that are sealed with ceramic stoppers that in each case contain an elongated capillary tube, termed stopper capillary below, of inside diameter K, and wherein an electrically conducting lead-through, which comprises an inner part and an outer part with reference to the discharge, is guided through this stopper capillary and is sealed outside with glass solder such that the outer part of the lead-through is sealed with glass solder over its length located in the stopper capillary, while an area, adjacent thereto, of the inner part of the lead-through is sealed over a small part of the length of from 1 to 2 mm by glass solder, there being fastened on the lead-through an electrode with a stem that projects into the interior of the discharge vessel, the outside diameter S of the inner part being coordinated with the inside diameter K, wherein the inner part is a composite component that comprises a core pin of diameter D onto which there is mounted as a double ply a coil with an effective diameter d of the coil wire, the following relationships being fulfilled:
0.8 K≦S≦0.98 K
d≦D
Dₘₐₓ≦0.5 mm
0.16 K≦D≦0.40 K
0.10 K≦d≦0.195 K.

2. The metal halide lamp as claimed in claim 1, wherein both plies of the coil are formed by a single wire.

3. The metal halide lamp as claimed in claim 2, wherein the two plies are wound oppositely to one another.

4. The metal halide lamp as claimed in claim 2, wherein it holds that:
0.12 K≦d≦0.195 K.

5. The metal halide lamp as claimed in claim 2, wherein it holds that:
0.25 K≦D≦0.30 K,
0.12 K≦d≦0.15 K.

6. The metal halide lamp as claimed in claim 2, characterized in that
D≦0.35 mm.

7. The metal halide lamp as claimed in claim 2, wherein it holds that:
(0.90 K−D)/4≦d≦(0.96 K−D).

8. The metal halide lamp as claimed in claim 2, wherein the wire diameter of the first and second plies is the same.

9. The metal halide lamp as claimed in claim 1, wherein the coil comprises a threefold ply.

10. The metal halide lamp as claimed in claim 1, wherein the coil comprises at least one ply that itself is doubly wound, the inner wire of diameter W being braided by a braiding wire of diameter w such that in formal terms a threefold ply of thickness W+2w is thereby achieved.

11. The metal halide lamp as claimed in claim 10, wherein the coil comprises two plies that are doubly wound such that in formal terms a sixfold ply is thereby achieved.

12. The metal halide lamp with ceramic discharge vessel as claimed in claim 1, wherein the discharge vessel consists of Al₂O₃.

13. The metal halide lamp with ceramic discharge vessel as claimed in claim 1, wherein the constituents of the inner part consist predominantly of one of the metals molybdenum and tungsten.

14. The metal halide lamp with ceramic discharge vessel as claimed in claim 1, wherein the outer part is a pin or tube made from niobium.
